(19) United States
(12) Patent Application Publication
(10) Pub. No.: US 2013/0138723 A1
(43) Pub. Date: May 30, 2013

(54) DYNAMIC BROWSER ICONS

(71) Applicants: Brian Nan Ku, Renton, WA (US); Ho Ki Wilson Lam, Bellevue, WA (US); David Martin Pryal, JR., Sammamish, WA (US)

(72) Inventors: Brian Nan Ku, Renton, WA (US); Ho Ki Wilson Lam, Bellevue, WA (US); David Martin Pryal, JR., Sammamish, WA (US)

(73) Assignee: Microsoft Corporation, Redmond, WA (US)

(21) Appl. No.: 13/308,294

(22) Filed: Nov. 30, 2011

(51) Int. Cl. G06F 15/16

(52) U.S. Cl. 709/203

(57) ABSTRACT

Dynamic icons are made easily available to third-party websites. In one embodiment, a dynamic icon is displayed on a client device, such as a phone, a laptop computer, a desktop computer, etc. The dynamic icon is associated with a third-party website and can have an address of the website associated therewith. The client device can receive information regarding how to update the dynamic icon and such information can be displayed in association with the dynamic icon. If selected, a browser is launched and the address is passed to the browser as an input parameter. The browser can use the address to access the third-party website and display a page of content associated with the website.

### FIELD

The present application relates generally to icons, and, particularly, to an icon that can be dynamically updated.

### BACKGROUND

Push technology describes a style of Internet-based communication where a request for a given transaction is initiated by a publisher or central server. By contrast, pull technology is where the request for the transmission of information is initiated by a receiver or client. Push services are often based on information preferences expressed in advance, which is often called a publish/subscribe model. In such a model, a client subscribes to various information channels. Whenever new content is available on one of those channels, the server pushes information out to the user.

Synchronous conferencing and instant messaging are typical examples of push services. Chat messages and sometimes files are pushed to the user when they are received by the messaging service. Email is also a well-known push system. In typical Email configurations, an SMTP protocol is used as a push protocol. However, the last step—from mail server to desktop computer—typically uses a pull protocol like POP3 or IMAP. Modern e-mail clients make this step seem instantaneous by repeatedly polling the mail server, frequently checking it for new mail.

Icons are small graphic symbols (usually simple pictures) that denote programs, commands, data files, etc. in a graphical user interface. For example, an icon can be used to launch an application (e.g., open Microsoft® Word®). Dynamic icons are also known. For example, dynamic icons are icons that can be updated, changed or animated. However, dynamic icons are typically associated with an application stored on a client device. Thus, an application needs to be developed that is specifically designed for a client device (e.g., “mobile phone app”). One example is a weather application that can be downloaded onto mobile phones. An icon associated with the weather application shows updates of local weather. A selection of the icon launches the weather application. The weather icon is updated through a push service whenever updates are available.

Greater accessibility to dynamic icons is desirable. In particular, it is desirable to allow for dynamic icons without the need to develop a client-specific application.

### SUMMARY

The present application allows for dynamic icons that are easily available to third-party websites. One advantage of several of the embodiments is that there is no need for a user to download a third-party specific application. Rather, multiple dynamic icons can be implemented using a standard browser.

In one embodiment, a dynamic icon is displayed on a client device. The dynamic icon is associated with a third-party website and can have an address of the website associated therewith. The client device can receive information representing an update of the dynamic icon and such information can be displayed in association with the dynamic icon. If selected, a browser is launched and the address is passed to the browser as an input parameter. The browser can use the address to access the third-party website and display a page of content associated with the website. The information can include a change of address to be accessed upon launching the browser.

In another embodiment, information can be dynamically passed from the client to the third-party website, such as the geolocation of the client device. The third-party website can then select the information to be sent to the client device to update the dynamic icon and the update can be dependent upon the geolocation. In one simple example, a third-party website can determine that the client device is within a certain proximity to a store and can update the dynamic icon with a store-specific sale to entice the user to shop.

In different embodiments the client device can either pull information from the third-party site to receive a dynamic update, or the third-party server can push information to the client device. In pull embodiments, the information for updating the dynamic icon can be stored in metadata located on the third-party website. For example, HTML tags (e.g., a div tag) can be used to store the information to be pulled.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The foregoing and other objects, features, and advantages of the invention will become more apparent from the following detailed description, which proceeds with reference to the accompanying figures.

### BRIEF DESCRIPTION OF THE DRAWINGS

FIG. 1 is an example mobile phone that can be used for updating a dynamic browser icon.

FIG. 2 is an example mobile phone showing a home screen including a dynamic browser icon.

FIG. 3 is an embodiment of a system for displaying a dynamic browser icon on a client device.

FIG. 4 is another embodiment of a system for displaying a dynamic browser icon.

FIG. 5 is a flowchart of a method for updating the dynamic browser icon.

FIG. 6 is a specific exemplary flowchart showing how the dynamic icon can be used with a third-party website.

FIG. 7 is a flowchart of an embodiment where a client device pulls information from a third-party website.

FIG. 8 is a flowchart of an embodiment for updating the dynamic browser icon.

FIG. 9 is a detailed flowchart of an embodiment for displaying content from a third-party website using the dynamic browser icon.

FIG. 10 is an embodiment showing that the dynamic browser icon can be updated across different client platforms.

### DETAILED DESCRIPTION

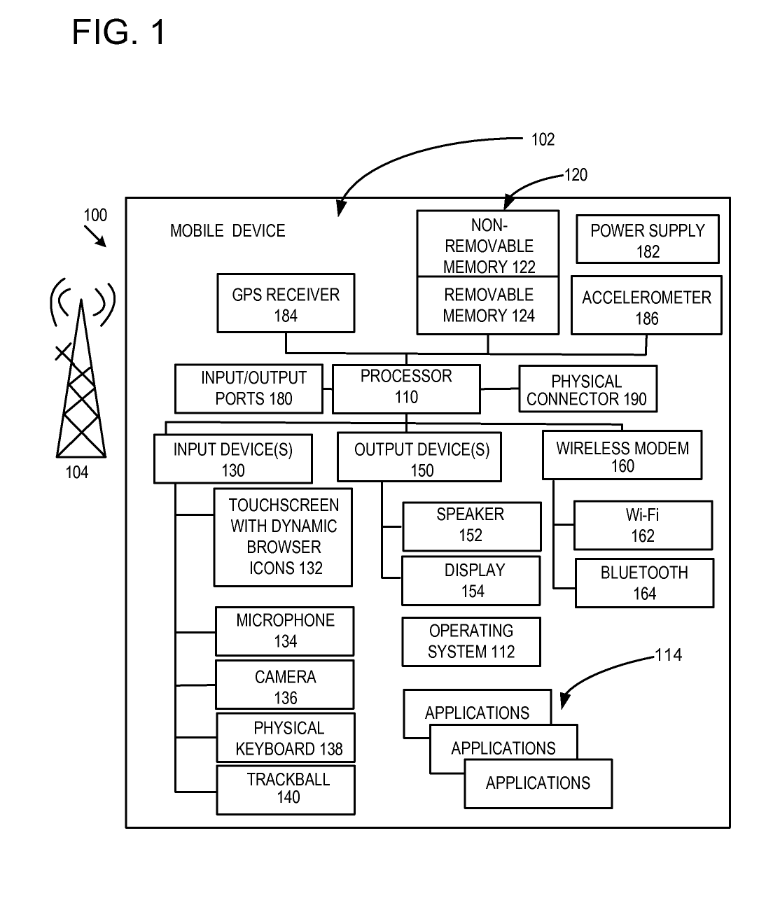

FIG. 1 is a system diagram depicting an exemplary mobile device 100 including a variety of optional hardware and software components, shown generally at 102. Any components 102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 104, such as a cellular or satellite network.

The illustrated mobile device 100 can include a controller or processor 110 (e.g., signal processor, microprocessor, ASIC, or other control and processing logic circuitry) for performing such tasks as signal coding, data processing, input/output processing, power control, and/or other functions. An operating system 112 can control the allocation and usage of the components 102 and support for one or more application programs 114. The application programs can include common mobile computing applications (e.g., email applications, calendars, contact managers, web browsers, messaging applications), or any other computing application.

The illustrated mobile device 100 can include memory 120. Memory 120 can include non-removable memory 122 and/or removable memory 124. The non-removable memory 122 can include RAM, ROM, flash memory, a hard disk, or other well-known memory storage technologies. The removable memory 124 can include flash memory or a Subscriber Identity Module (SIM) card, which is well known in GSM communication systems, or other well-known memory storage technologies, such as “smart cards.” The memory 120 can be used for storing data and/or code for running the operating system 112 and the applications 114. Example data can include web pages, text, images, sound files, video data, or other data sets to be sent to and/or received from one or more network servers or other devices via one or more wired or wireless networks. The memory 120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 100 can support one or more input devices 130, such as a touchscreen 132, microphone 134, camera 136, physical keyboard 138 and/or trackball 140 and one or more output devices 150, such as a speaker 152 and a display 154. Other possible output devices (not shown) can include piezoelectric or other haptic output devices. Some devices can serve more than one input/output function. For example, touchscreen 132 and display 154 can be combined in a single input/output device. The touchscreen 132 can support dynamic browser icons. The dynamic browser icons can be displayed on a home screen, which is typically the screen displayed when the phone is powered on. The home screen is the base screen that generally cannot be further minimized and that contains icons representing applications. As further described below, a dynamic browser icon is an icon whose image can change based on updates generated by a third-party website. Additionally, the dynamic browser icon is an icon that launches a browser upon selection. The browser is then passed an address to use as a startup page.

A wireless modem 160 can be coupled to an antenna (not shown) and can support two-way communications between the processor 110 and external devices, as is well understood in the art. The modem 160 is shown generically and can include a cellular modem for communicating with the mobile communication network 104 and/or other radio-based modems (e.g., Bluetooth or Wi-Fi). The wireless modem 160 is typically configured for communication with one or more cellular networks, such as a GSM network for data and voice communications within a single cellular network, between cellular networks, or between the mobile device and a public switched telephone network (PSTN).

The mobile device can further include at least one input/output port 180, a power supply 182, a satellite navigation system receiver 184, such as a Global Positioning System (GPS) receiver, an accelerometer 186, and/or a physical connector 190, which can be a USB port, IEEE 1394 (FireWire) port, and/or RS-232 port. The illustrated components 102 are not required or all-inclusive, as any components can deleted and other components can be added.

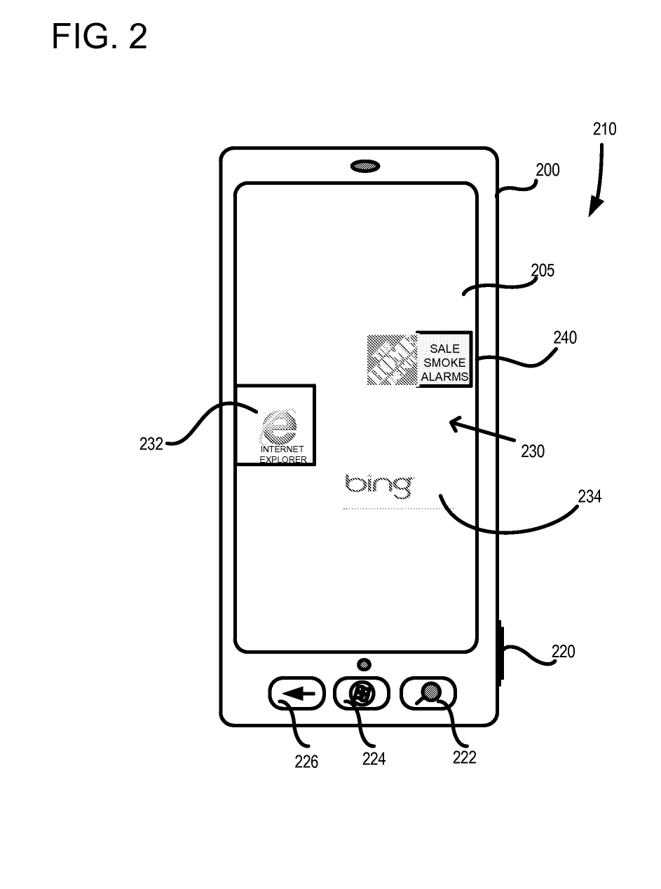

FIG. 2 depicts a front view 210 of an example mobile device 200 displaying a graphical user interface (GUI) on a touchscreen display 205. The mobile device 200 can also include several hardware buttons, including a camera shutter button 220 located on a side surface of the mobile device, as well as a search button 222, a home button 224, and a back button 226, which can be located on a front surface of the mobile device. These hardware buttons can be used for invoking and/or executing various operations using the mobile device 200. However, these buttons can be eliminated or other buttons can be added. The camera shutter button 220 can be used for invoking and/or executing an image capture application, as well as controlling functions within the image capture application, such as autofocusing and/or operating a camera shutter. Search button 222 can be used to invoke and/or execute a user interface for searching data. Home button 224 can be used for navigating software functionality on the mobile device by, for example, setting the mobile device to a home screen, or invoking other assigned functionality. Back button 226 can be used for navigating software functionality by, for example, requesting a previously requested object that was viewed using the mobile device 200.

When the mobile device 200 is turned on or the home button 224 is selected, the touchscreen display returns to the home screen, which is shown. The home screen is the base screen that, generally, cannot be minimized and that displays icons, shown generally at 230. Any number of icons can be located on the home screen, but only three are shown for purposes of illustration. The icons can represent applications that are locally stored and launched upon selection of the icon. For example, a browser icon 232 is shown that launches the browser upon selection. Launching of the browser causes a window to be opened that generally includes buttons or menus for user input commands. The browser can automatically open to a predetermined page based on settings associated with the browser. The browser icon 232 is generally considered a static icon, as it does not change appearance. Another static icon 234 is also shown. The static icon 234 represents an Internet site and can be stored as an icon in the same way as a “favorite” is stored in traditional browsers. Thus, the static icon 234 is used to launch a browser and to open a page associated with the static icon, in this example, a Bing page. Icon 240 is a dynamic icon. A dynamic icon can change appearance based on information provided from a third-party website. For example, the icon 240 is for a store called “The Home Depot”, which is currently shown having a sale on smoke alarms. As such, the icon has been changed to reflect the current sale. Other forms can be used to display the dynamic icon. An Internet address associated with the icon can also be dynamically updated. Thus, if a user selects the icon 240, a browser is launched with a parameter passed to the browser associated with the sale. A webpage associated with the sale can then be opened. Although not shown, additional dynamic icons can be used that are used to launch the browser application. Thus, multiple dynamic icons can be linked to a single browser application, each dynamic icon representing a potentially different startup page.

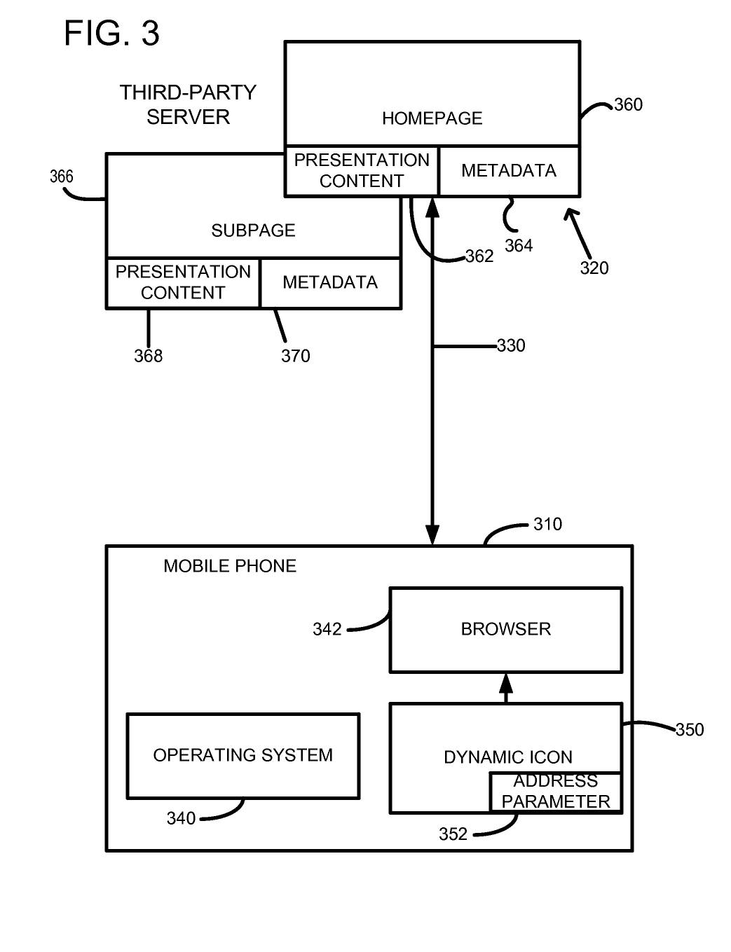

FIG. 3 is an embodiment showing a system for implementing a dynamic browser icon. There are multiple techniques that can be used to implement a dynamic browser icon and FIG. 3 is merely one example. A mobile phone 310 is coupled to a third-party server 320 through a network 330. The mobile phone 310 includes an operating system 340, a browser application 342, and a dynamic icon 350, which is displayed on a user interface of the mobile phone. The dynamic icon can be associated with an address parameter 352. The dynamic icon is a link to launch the browser 342, but with a particular Internet address associated with the address parameter. The Internet address is, thus, passed to the browser so that the browser knows a startup page to download. In this way, multiple dynamic icons can be located on the home screen, and each can be used to launch the same browser application, but with different Internet addresses to use for the startup page. Thus, the same application can be used to create multiple dynamic icons.

To obtain updates, the mobile phone connects to a third-party server 320 through a network shown generically at 330. A homepage 360 can be associated with the Internet address in the address parameter 352. The homepage can be written in a markup language, such as HTML, and can include presentation content 362, which is used to generate visible content to the user, and metadata, which is not used in generating visible content. In some embodiments, the metadata can be used to pass dynamic information to the mobile phone 310 in order to update the dynamic icon. For example, a tag (e.g., a div tag) can be searched on the homepage in order to determine if dynamic content is available. An example of using a div identifier is as follows:

Using a div ID

<html lang=”en-US”>
<head>
<title>HomeDepot.com Mobile</title>
<meta http-equiv=″X-UA-Compatible″ content=″IE=7″/>
<meta name=″viewport″ content=″width=device-width″/>
<script type=”text/javascript src=”MobileTile.js” async=”true”></script>
</head>
<body>
...
<div id=”MobileTile” localUrl=””>
</div>
</body>
</html>

Cascading style sheets can alternatively be used. An example is as follows:

Using a CSS style

<html lang=”en-US”>
<head>
<title>HomeDepot.com Mobile</title>
<meta http-equiv=″X-UA-Compatible″ content=″IE=7″/>
<meta name=″viewport″ content=″width=device-width″/>
<script type=”text/javascript src=”MobileTile.js” async=”true”></script>
</head>
<body>
...
<div id=”MobileTile” class=”MobileTileClass” localUrl=””>
</div>
</body>
</html>

Other techniques can alternatively be used, such as an RSS feed.

The homepage 360 can have a link located thereon that, upon selection, displays a subpage 366, as is well understood in the art. The subpage 366 can also include presentation content 368 and metadata 370 that can be used for updating the dynamic icon 350. When updating the dynamic icon 350, the address parameter 352 can be modified to change the startup page used by the browser 342. For example, if the third-party server wishes to redirect a user of the mobile phone 310 to a subpage 366 because of a sale item, the address parameter 352 can be modified to be a pointer to the sale, and an image associated with the dynamic icon can be modified so that the user is aware of the sale.

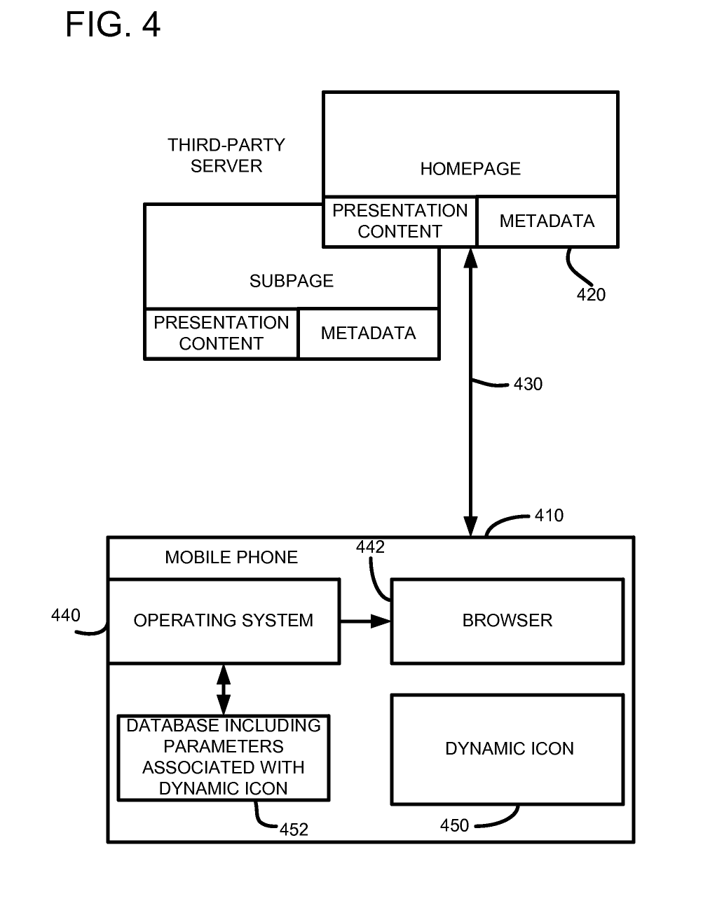

FIG. 4 is an alternative embodiment wherein a mobile phone 410 can communicate with a third-party server 420 through a network 430. An operating system 440 can be used to launch a browser 442 in response to selection of a dynamic icon 450. When the selection of the dynamic icon 450 is made, the operating system 440 accesses a database 452 that includes parameters associated with the dynamic icon. For example, an address parameter can be stored and passed by the operating system to the browser. Updates to the dynamic icon can be made via the operating system, which can update the database 452. The remaining aspects of FIG. 4 can behave similarly to that already described in relation to FIG. 3.

In either embodiment of FIG. 3 or FIG. 4, the mobile device can pull updates from the third-party server. In one example, such pulling occurs by searching a website page for appropriate HTMLs tags (e.g., a div tag) and upon finding such a tag, using the data associated with the tag as a dynamic update. The timing of when a pull occurs can depend on a number of factors. For example, in order to conserve battery life, pulls can depend on connection to a power source, upon exiting a sleep mode, when connected to Wi-Fi, or when the user connects to the third-party site. The update can be modified based on the mobile device. For example, the mobile device can pass a browser type or other information through a header (e.g., a user agent) to the third-party server. In response to such information, the third-party website can modify the update, such as making an update that is best suited for the particular browser type. Push type updates can occur by the third-party website actively pushing data to the mobile client for updating the address associated with the dynamic icon. Additionally, although a mobile phone is disclosed, a variety of platforms can be used instead, such as a laptop computer, desktop computer, tablet, etc.

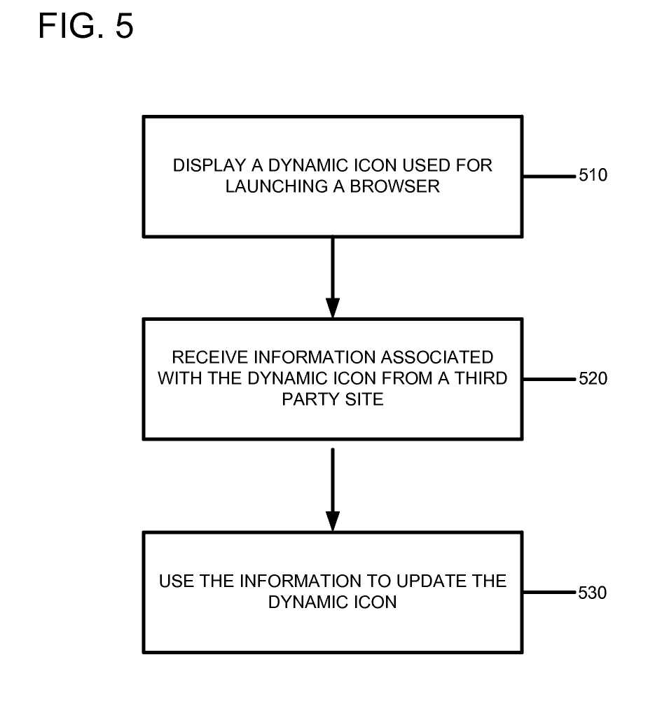

FIG. 5 is a flowchart of a method for updating a dynamic browser icon. In process block 510, a dynamic icon used for launching a browser is displayed. In process block 520, information is received that is associated with the dynamic icon. The information can be from a third-party server and includes updates to the dynamic icon, including image updates, and/or an address update. In process block 530, the updates are displayed in association with the dynamic icon.

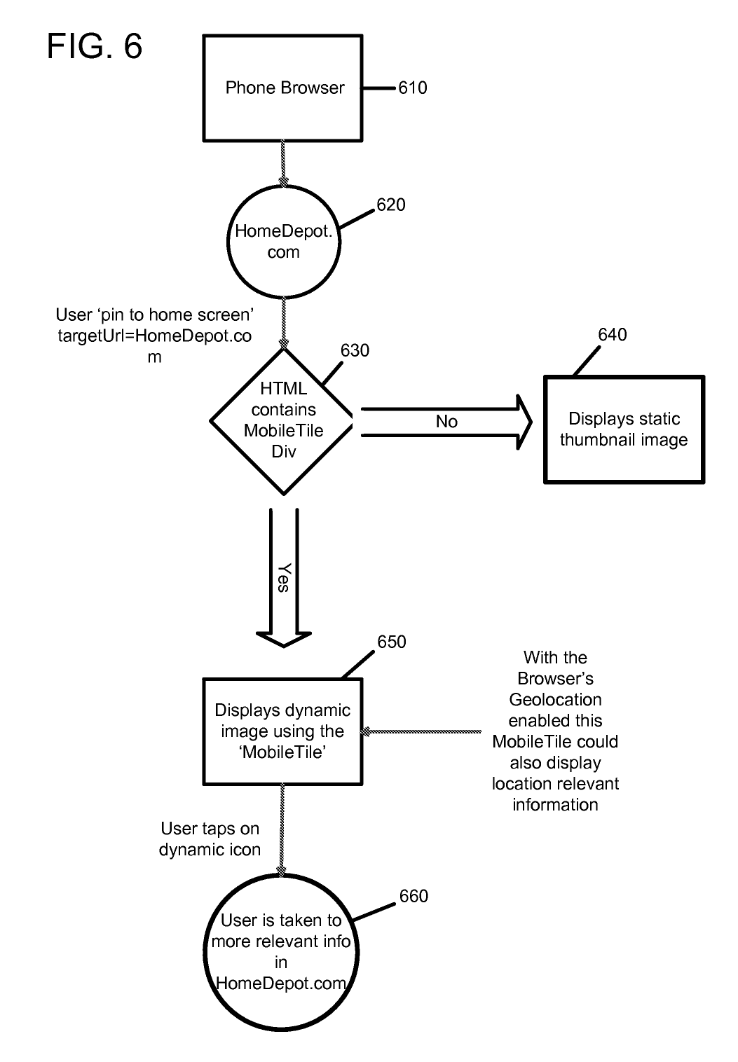

FIG. 6 is a flowchart of a particular embodiment in which the third-party website is “Home Depot” for purposes of illustration. In process block 610, a phone browser is used to access the Home Depot site 620. A user then performs a command that pins the site 620 to the user's home screen. The phone (e.g., the operating system) searches the website for a div tag having a “mobiletile” div. If such a div tag is not found, then in decision block 630, a browser icon is generated that displays a simple static thumbnail image (process block 640). If the div tag is found, then a dynamic icon is generated using data obtained from the mobiletile div (process block 650). An image and/or text data can be pulled from the div section and used to generate the dynamic icon. If geolocation is also used, the generated dynamic icon can incorporate location-relevant information supplied from the third-party server. Subsequently, when a user selects the dynamic icon, a browser is launched and data associated with the dynamic icon is passed to the browser. In this case, a subpage of the Home Depot site is passed to the browser so that the site can be downloaded upon launch (process block 660).

An example code segment is shown below and can be used to update the metadata on the third-party site. Specifically, the current position of the phone is passed to the third-party site. The third-party site can use the position information to determine if the phone position is equal to a store location. If so, the metadata used to update the dynamic icon can be customized for that phone to provide particular details about the store location. The metadata can include a browser identifier obtained from the user agent information received from the phone.

MobileTile.js

```
function updateMobileTile( ) {
  /* navigator.geolocation.getCurrentPosition(checkPosition,
  displayError); */
  /* update MobileTile */
}
function checkPosition(position) {
  /* if position equal a local HomeDepot store location then display
  local store info */
  var divMobileTile =document.getElementById(”MobileTile”);
  var contentLocal =getLocalStoreContent(position);
  var contentLocalUrl =getLocalStoreContentUrl(position);
  divMobileTile.innerHTML =contentLocal;
  divMobileTile.setAttribute(“targetUrl”, contentLocalUrl );
}
function displayError(positionError) {
  /* an error occurred or unable to get current position then display or
  not display info */
}
```

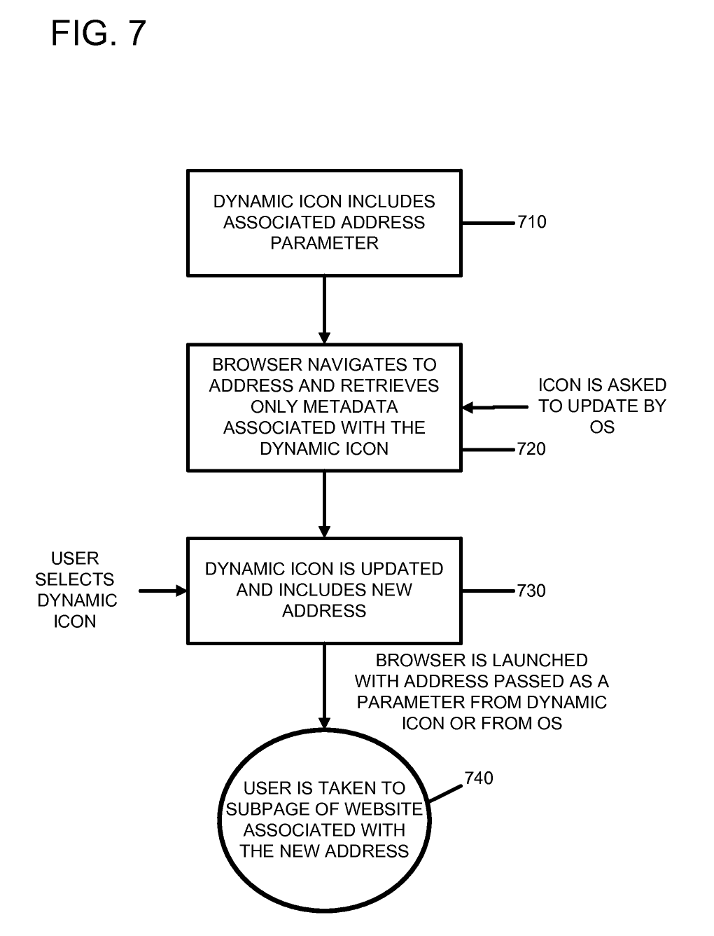

FIG. 7 is a flowchart of a method for updating a dynamic icon. In process block 710, a dynamic icon can include an address parameter associated therewith. The dynamic icon can have associated code that responds to simple requests from the operating system using the browser application. For example, in process block 720, the operating system can request that the dynamic icon be updated. In response to this request, the dynamic icon can control that the browser navigates to an address in the address parameter and retrieves metadata associated with the dynamic icon. The address can be a third-party website, which includes metadata and content for display. In process block 730, the dynamic icon can be updated using the metadata, including a new address being stored as the address parameter. The new address can, for example, be a subpage associated with a website. If the user selects the dynamic icon, a browser is launched using the new address as a parameter (which can be provided from the dynamic icon or from the operating system). The browser then displays content of the subpage of the website (process block 740).

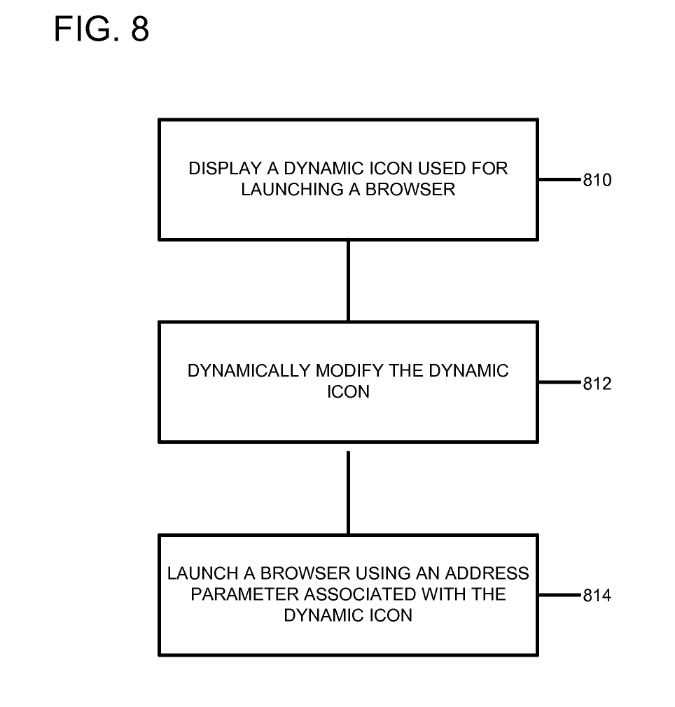

FIG. 8 is a flowchart of a method for updating a client device using a dynamic icon. In process block 810, a dynamic icon is displayed, such as on a home screen of a user device. In process block 812, the dynamic icon is modified automatically based on information pushed or pulled from a third-party website hosted by a third-party server. In process block 814, in response to user selection of the icon, a browser is launched using an address parameter passed to the browser. The address parameter can be passed using code associated with the icon itself, or, alternatively, an operating system can pass the address parameter to the browser. In any event, the browser is launched with a parameter passed to it in association with a dynamic icon. Multiple different dynamic icons can be used to launch the browser, and each dynamic icon can send the browser a different address (e.g., URL) to use as a first startup page to be displayed.

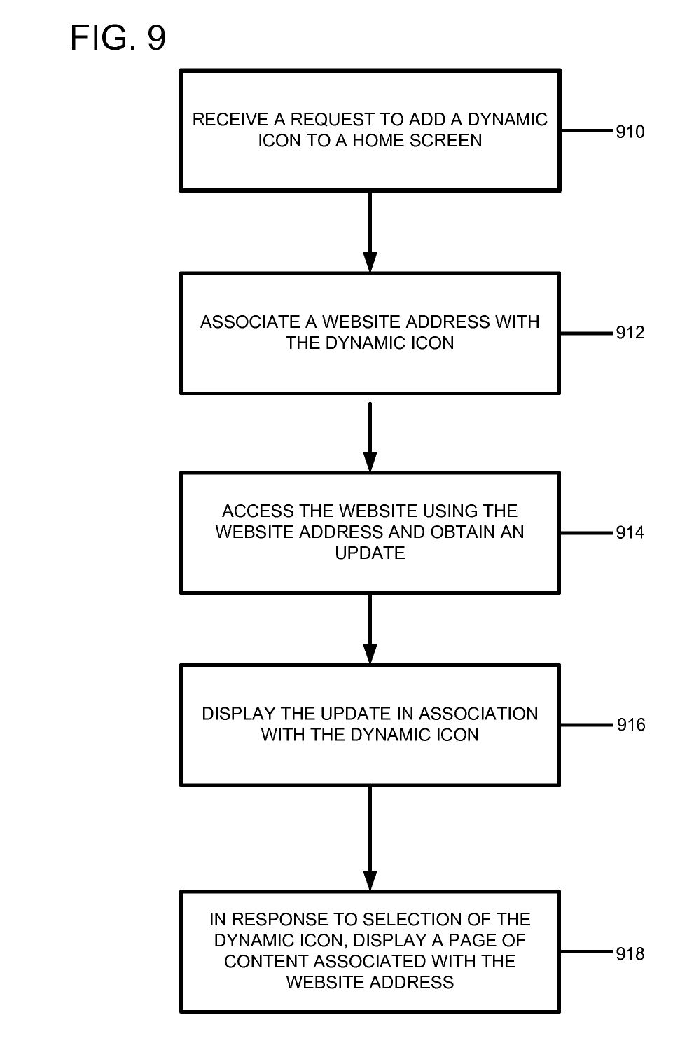

FIG. 9 is a detailed flowchart of a method for generating and updating a dynamic icon. In process block 910, a request is received to add a dynamic icon to a home screen. With many client devices, it is possible to navigate to or otherwise access a website and then generate an icon using a simple command, such as a pin command. The icon, which is associated with the website, is generated and placed at a position on the home screen with other icons. In process block 912, a website address is associated with the dynamic icon. The website address can be stored in code associated with the dynamic icon itself, or stored in a database accessible by the icon or by an operating system. In process block 914, the website address is used to obtain an update. Typically, the website is searched for special commands regarding dynamic icon updates, such as by using markup language tags. In process block 916, the dynamic icon image is updated so as to display the update. A typical update is to change the website address associated with the dynamic icon so that selection of the icon accesses the changed address. In process block 918, in response to a user selection of the dynamic icon that now features the update, a page of content is displayed associated with the website address.

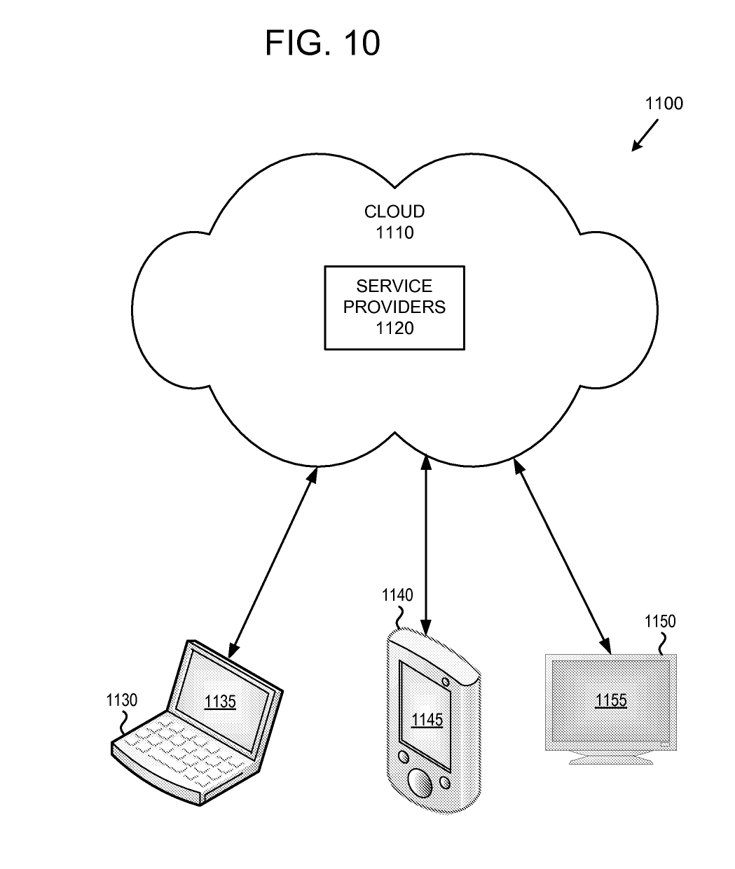

FIG. 10 illustrates a generalized example of a suitable implementation environment 1100 in which described embodiments, techniques, and technologies may be implemented.

In example environment 1100, various types of services (e.g., computing services) are provided by a cloud 1110. For example, the cloud 1110 can comprise a collection of computing devices, which may be located centrally or distributed, that provide cloud-based services to various types of users and devices connected via a network such as the Internet. The implementation environment 1100 can be used in different ways to accomplish computing tasks. For example, some tasks (e.g., processing user input and presenting a user interface) can be performed on local computing devices (e.g., connected devices 1130, 1140, 1150) while other tasks (e.g., storage of data to be used in subsequent processing) can be performed in the cloud 1110.

In example environment 1100, the cloud 1110 provides services for connected devices 1130, 1140, 1150 with a variety of screen capabilities. Connected device 1130 represents a device with a computer screen 1135 (e.g., a mid-size screen). For example, connected device 1130 could be a personal computer, such as desktop computer, laptop, notebook, netbook, or the like. Connected device 1140 represents a device with a mobile device screen 1145 (e.g., a small size screen). For example, connected device 1140 could be a mobile phone, smart phone, personal digital assistant, tablet computer, or the like. Connected device 1150 represents a device with a large screen 1155. For example, connected device 1150 could be a television screen (e.g., a smart television) or another device connected to a television (e.g., a set-top box or gaming console) or the like. One or more of the connected devices 1130, 1140, 1150 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1100. For example, the cloud 1110 can provide services for one or more computers (e.g., server computers) without displays.

Services can be provided by the cloud 1110 through service providers 1120, or through other providers of online services (not depicted). For example, cloud services can be customized to the screen size, display capability, and/or touchscreen capability of a particular connected device (e.g., connected devices 1130, 1140, 1150).

In example environment 1100, the cloud 1110 provides the technologies and solutions described herein to the various connected devices 1130, 1140, 1150 using, at least in part, the service providers 1120. For example, the service providers 1120 can provide a centralized solution for various cloud-based services. The service providers 1120 can manage service subscriptions for users and/or devices (e.g., for the connected devices 1130, 1140, 1150 and/or their respective users).

Dynamic icons can be integrated across devices 1130, 1140, and 1150, such that any updates of the dynamic icon on one device can be propagated to the other devices for users that have a common account across devices.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method of updating a client device, comprising:
displaying a dynamic icon on the client device, wherein the dynamic icon is for launching a browser stored on the client device and for accessing a third-party website associated with the dynamic icon;
receiving information on the client device associated with the dynamic icon from the third-party website; and
using the information to update the dynamic icon on the client device by displaying the information in association with the dynamic icon.

2. The method of claim 1, further including retrieving the information from metadata stored on the third-party website.

3. The method of claim 2, wherein retrieving the information includes searching the third-party website for a markup language tag and retrieving the information associated with the markup language tag.

4. The method of claim 1, wherein displaying the dynamic icon is on a home screen of the client device, which is a base screen from which other applications can be launched, and the dynamic icon is associated with an address parameter that is passed to the browser for launching the browser.

5. The method of claim 1, wherein the dynamic icon includes code that accesses the third-party website for receiving the information.

6. The method of claim 1, further including sending to the third-party website a browser type, and, in response thereto, the third-party website updating the information for the dynamic icon.

7. The method of claim 1, further including sending a geolocation of the client device to the third-party website, and the third-party website updating the information based on the geolocation.

8. The method of claim 1, further including accessing the third-party website and generating an icon on the client device associated with the third-party website in response to a user request.

9. The method of claim 1, wherein the information includes changing an address associated with the dynamic icon so that selection of the icon accesses the changed address.

10. One or more computer-readable storage having stored thereon computer-executable instructions operable to cause a mobile computing device to perform a method comprising:
displaying a dynamic icon associated with a third-party website;
dynamically modifying the dynamic icon based on an update from the third-party website; and
in response to receiving user input selecting the dynamic icon, launching a browser on the mobile computing device and accessing a website address associated with the dynamic icon using the browser.

11. The computer-readable storage of claim 10, further including retrieving the update from metadata stored on the third-party website and wherein the update includes modifying the website address associated with the dynamic icon.

12. The computer-readable storage of claim 11, wherein retrieving the update includes searching the third-party website for a markup language tag and retrieving the update associated with the markup language tag.

13. The computer-readable storage of claim 10, wherein the dynamic icon is displayed on a home screen of the mobile computing device.

14. The computer-readable storage of claim 10, wherein the dynamic icon includes software that accesses the third-party website for receiving the update.

15. The computer-readable storage of claim 10, further including identifying to the third-party website, a browser type, and, in response thereto, the third-party website storing the update associated with the browser type.

16. The computer-readable storage of claim 10, further including sending a geolocation of the client device to the third-party website, and the third-party website storing the update based on the geolocation.

17. The computer-readable storage of claim 10, further including accessing the third-party website and generating an icon on the client device associated with the third-party website in response to a user request.

18. The computer-readable storage of claim 10, wherein the update includes changing an address associated with the dynamic icon so that selection of the icon accesses the changed address.

19. A method of presenting dynamic information on a phone, comprising:
receiving a request to add a dynamic icon to a home screen on a phone;
associating a website address with the dynamic icon;
accessing a website using the website address and obtaining an update of information associated with the dynamic icon;
displaying the update on the phone in association with the dynamic icon; and
in response to receiving a selection of the dynamic icon, launching a browser and displaying a page of content associated with the website address.

20. The method of claim 19, further including providing a geolocation of the phone to a server computer associated with the website, and receiving the update based on the geolocation.
